(19) United States
(12) Patent Application Publication
(10) Pub. No.: US 2008/0128029 A1
(43) Pub. Date: Jun. 5, 2008

(54) METHOD, SYSTEM AND COMPUTER PRODUCT FOR ENSURING BACKUP GENERATOR FUEL AVAILABILITY

(75) Inventor: Walter T. Gorman, Short Hills, NJ (US)

Correspondence Address: CANTOR COLBURN, LLP, 20 Church Street, 22nd Floor, Hartford, CT, 06103, US

(73) Assignee: WALTER T. GORMAN LLC, Rockaway Park, NY (US)

(21) Appl. No.: 11/566,726

(22) Filed: Dec. 5, 2006

(51) Int. Cl. B67D 5/60; F17D 1/02; G05B 15/00; B65B 31/02

(52) U.S. Cl. 137/209; 137/14; 141/4; 700/275

(57) ABSTRACT

Disclosed herein is a method that relates to ensuring backup generator fuel availability. The method includes, receiving natural gas at a local backup power generation site via pipeline, compressing the natural gas and then containing the natural gas in compressed form until needed pursuant to power outage. The method further includes regulating the compressed natural gas to a pressure appropriate for a backup generator subsequent to a power outage.

### BACKGROUND OF THE INVENTION

A source of reliable electrical power to many facilities, such as hospitals, for example, is important enough that some facility administrators are installing systems to generate power on site. Such on site power generators can augment external power sources during reductions in supply as well as during complete power outages.

Some backup generators operate on natural gas that is supplied via pipeline. Depending upon the circumstances and duration of a power outage the supply of natural gas, however, may also be interrupted. In such cases backup generators that run on natural gas may cease to supply power for lack of natural gas to fuel them. Consequently, a fuel reserve to power backup power generators would be well received in the art.

### BRIEF DESCRIPTION OF THE INVENTION

Disclosed herein is a method that relates to ensuring backup generator fuel availability. The method includes, receiving natural gas at a local backup power generation site via pipeline, compressing the natural gas and then containing the natural gas in compressed form until needed pursuant to power outage. The method further includes regulating the compressed natural gas to a pressure appropriate for a backup generator subsequent to a power outage.

Further disclosed herein is a system that relates to a backup generator fuel supply system. The system includes, at least one compressed natural gas storage tank located at a site of a backup generator and a compressor that compresses pipeline supplied natural gas to a pressure appropriate for storage in the at least one compressed natural gas storage tank. The system further includes a regulator that regulates pressure of natural gas exiting the at least one compressed natural gas storage tank to a pressure appropriate for a backup generator.

Further disclosed herein is a computer program product for ensuring backup generator fuel. The computer program product includes a storage medium readable by a processing circuit and storing instructions for execution by the processing circuit for facilitating a method. The method includes, monitoring availability of natural gas via a pipeline, monitoring a fill level of compressed natural gas in at least one storage tank, and refilling the at least one storage tank in response to the fill level of the at least one storage tank being less than a preset minimum fill level and natural gas being available via the pipeline.

### BRIEF DESCRIPTION OF THE DRAWINGS

The following descriptions should not be considered limiting in any way. With reference to the accompanying drawings, like elements are numbered alike:

FIG. 1 depicts a schematic of a backup power generation system with an automatically replenished reserve fuel supply disclosed herein; and

FIG. 2 depicts a block diagram of the backup power generation system of FIG. 1.

### DETAILED DESCRIPTION OF THE INVENTION

A detailed description of embodiments of the disclosed system and method are presented herein by way of exemplification and not limitation with reference to the Figures.

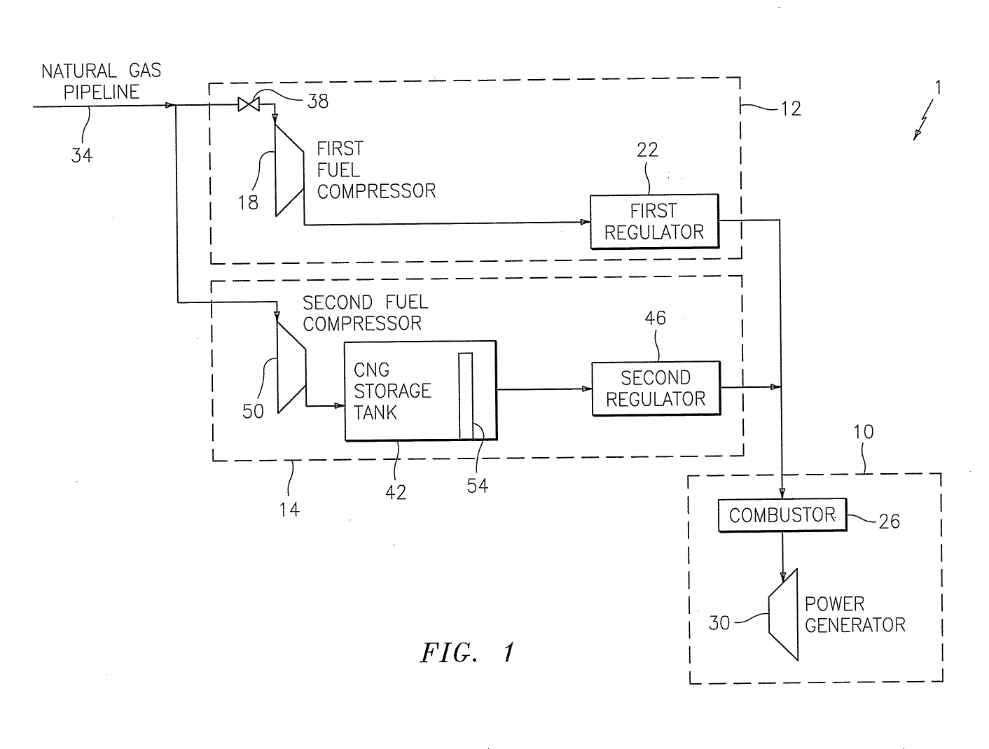

Referring to FIG. 1 an embodiment of a backup electrical power generation system with an automatically replenished reserve fuel supply is shown schematically at 1. The generation system 1 may be located at a hospital or other facility in need of back up electrical power, for example. The generation system 1 can augment the electrical power received from external sources such as an electrical utility, for example. Electrical circuitry (not shown) can monitor the supply of remote electrical power as well as the demand for electrical power from within the facility. If the demand is higher than the available supply, the backup power generation system 1 can generate and supply the needed electrical power to the facility. Optionally, the backup power generation system 1 may provide electrical power to an external power distribution system, sometimes referred to as “the grid.” In such a situation the facility operating the power generation system 1 will actually produce more power than the facility consumes and can sell to “the market” this excess power supplied to the grid. Depending upon the cost of production by the generation system 1 and the price of electricity on “the market” it may, at times, be economically advantageous to produce electrical power even when the grid has sufficient power to supply to the facility.

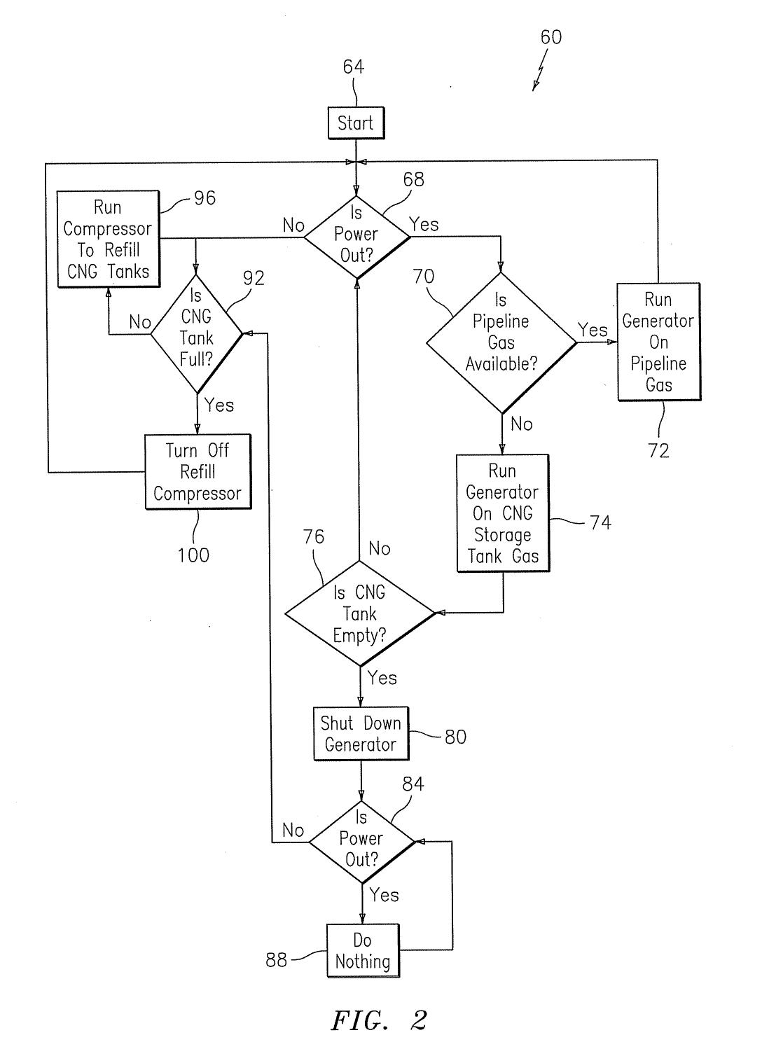

The generation system 1 includes, a power generator portion 10, a pipeline feed portion 12, and a reserve fuel storage portion 14. The power generator portion 10 among other things includes a combustor 26 and a generator 30, depicted herein as a micro turbine power generator. It should be noted that the power generation portion 10 could include multiple combustors 26 and multiple generators 30. The micro turbine generator 30 can generate electrical power from natural gas. The natural gas supplied to the generator 30 can be supplied from a natural gas pipeline 34 through the pipeline feed portion 12 or from the reserve fuel storage portion 14. The source of the natural gas supplied to the generator portion 10 can depend upon several factors some of which will be described with reference to FIG. 2 below. Regardless of the source of supply gas the combustor 26 requires the incoming gas to be maintained at specific pressures, generally in the range of 40 to 500 pounds per square inch, however the exact pressure range depends upon the specifics of each particular application.

When the gas supplied to the generator portion 10 is supplied from the pipeline 34 a shutoff valve 38 is maintained in an open position to allow the gas to flow to the pipeline feed portion 12. The pipeline feed portion 12 includes among other things a first gaseous fuel compressor 18 and a first pressure regulator 22. The first gaseous fuel compressor 18 increases the pressure of the gas from the pressure in which it is received from the pipeline 34 to a pressure higher than what is required by the combustor 26. This elevated pressure allows the first pressure regulator 22 to regulate the pressure down to the pressure range required of the combustor 26. The pressure-regulated natural gas is burned in the combustor 26 to release energy that is used by the generator 30 in the production of electricity.

When the gas supplied to the generator 30 is supplied from the reserve fuel storage portion 14, the shutoff valve 38 is maintained in a closed position and the first gaseous fuel compressor 18 is not operated. Compressed natural gas (CNG) stored under high pressure, typically between 3,600 and 5,100 pounds per square inch, in one or more storage tanks 42, is regulated to the pressure range required of the combustor 26 by a second pressure regulator 46. The pressure-regulated gas is burned in the combustor 26 to release energy that is used by the generator 30 in the production of electricity. In an alternate embodiment the first compressor 18 and the second compressor 50 could be the same compressor. As such the compressor 18, 50 would serve the needs of both the pipeline feed portion 12 as well as the reserve fuel storage portion 14 through additional porting and valving (not shown). Similarly, in an alternate embodiment the first regulator 22 and the second regulator 46 could be the same regulator. As such the regulator 22, 46 would serve the needs of both the pipeline feed portion 12 as well as the reserve fuel storage portion 14 through additional porting and valving (not shown).

The duration of time for which the reserve fuel storage portion 14 can supply the generator portion 10 depends on many factors including such things as; the volume and pressure of the natural gas stored in the storage tanks 42, the number, size and generating capacity of the generators 30 and the consumption rate of the electricity being produced. Consequently the design of the electrical power generation system 1 should tale these and other concerns, such as the desired minimum time duration of power generation, into consideration. The duration also depends in part on how depleted the storage tanks 42 are allowed to become before they are replenished. A natural gas tank quantity sensor 54 may be used to monitor the quantity of natural gas in the storage tanks 42 and a control system may then control at what quantity to replenish them.

Replenishment of compressed natural gas in the storage tanks 42, when the tanks 42 have become depleted, can be performed regardless of whether the power generation portion 10 is consuming gas from the storage tanks 42 or not. Replenishing the tanks 42 while the generation portion is not consuming gas will expedite the replenishment process. A second gaseous fuel compressor 50 increases the pressure of natural gas from the pipeline 34 to an acceptable pressure range for storage as compressed natural gas and supplies the gas to the storage tanks 42 in the replenishment process. The natural gas tank quantity sensor 54 can monitor the fill level of the tanks 42 during filling to provide feedback as to when replenishment is complete. A control system using the gas tank quantity sensor 54 as an input will be described in more detail below.

Referring to FIG. 2 a control system block diagram is shown generally at 60. Block 64 indicates the start of the process. At block 68 a determination is made as to whether there is a power outage or not. If there is a power outage, then block 70 is performed to determine if pipeline gas is available. Block 72 is performed and the generator is run on pipeline supplied gas in response to block 70 indicating that pipeline gas was available. Block 68 is returned to determine if the power outage is still in effect after block 72 is performed. If block 70 indicates that pipeline gas is not available then block 74 is performed and the backup generator 30 is run on gas supplied from the CNG storage tanks 42. In block 76 a determination is made as to whether the CNG storage tanks 42 are empty. If the CNG storage tanks 42 are not empty then the generator 30 continues to run and the process is continued at block 68. If the CNG storage tanks 42 are empty then the process continues at block 80 and the generator 30 is shut down. After the generator 30 is shut down block 84 is performed wherein a determination is made as to whether the power outage is still in effect. No change is made, as indicated by Block 88, in response to the power outage remaining in effect. In response to the power outage having ceased as determined by block 84 the process continues at block 92 wherein a determination is made as to whether the CNG storage tanks 42 are full or not.

Block 92 is also performed in response to the answer to block 68 being that a power outage is not in effect. Block 92 determines whether or not the CNG storage tanks 42 are full. In block 96 the second fuel compressor 50 is run to refill the CNG storage tanks 42 with gas from the pipeline 34 in response to block 92 determining that the CNG storage tanks 42 were not full. Block 100 is performed and the tank refill compressor 50 is not run in response to block 92 determining that the CNG storage tanks 42 were full. At this point a power outage is not in effect and the CNG storage tanks 42 are full so the process is returned to the start at block 68.

Through the control system 60 just described the backup power generation system 1 maintains the CNG storage tanks 42 at as full a level as possible thereby providing a reserve of fuel for which the backup generator 30 can run during power outages.

As described above, embodiments may be in the form of computer-implemented processes and apparatuses for practicing those processes. In exemplary embodiments, the invention is embodied in computer program code. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. The technical effect of the executable instructions is to ensure that a backup reserve of natural gas is stored in compressed form at a facility for usage during a power outage to the facility from external power sources.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A method of ensuring backup generator fuel availability, comprising:
receiving natural gas at a local backup power generation site via pipeline;
compressing the natural gas;
containing the natural gas in compressed form until needed pursuant to power outage; and
regulating the compressed natural gas to a pressure appropriate for a backup generator subsequent to a power outage.

2. The method of claim 1, further comprising:
storing the compressed natural gas in at least one storage tank at the backup power generation site.

3. The method of claim 2, further comprising:
monitoring the fill level of compressed natural gas in the at least one storage tank.

4. The method of claim 2, further comprising:
refilling the at least one storage tank in response to the fill level of the at least one storage tank being less than a preset minimum fill level.

5. The method of claim 4, wherein the preset minimum fill level is a full tank.

6. The method of claim 2, further comprising:
refilling the at least one storage tank in response to a power outage being terminated.

7. The method of claim 2, further comprising:
refilling the at least one storage tank in response to natural gas being available via pipeline.

8. The method of claim 1, further comprising:
monitoring electrical power supplied to a facility from a source other than a backup power generator to determine when there is a power outage.

9. The method of claim 1, further comprising:
compressing natural gas for containment in compressed form with a same compressor that compresses streaming natural gas from a pipeline for continuous feed to a power generator.

10. The method of claim 1, further comprising:
regulating pressure of contained compressed natural gas for feeding to a power generator with a same regulator that regulates pressure from a continuous stream of compressed pipeline supplied natural gas.

11. The method of claim 1, wherein the generator is a micro turbine generator.

12. A backup generator fuel supply system, comprising:
at least one compressed natural gas storage tank located at a site of a backup generator;
a compressor that compresses pipeline supplied natural gas to a pressure appropriate for storage in the at least one compressed natural gas storage tank; and
a regulator that regulates pressure of natural gas exiting the at least one compressed natural gas storage tank to a pressure appropriate for a backup generator.

13. The system of claim 12, further comprising:
a tank gas quantity sensor that monitors an amount of compressed natural gas stored in the at least one compressed natural gas storage tank.

14. The system of claim 12, further comprising:
a pressure gage that monitors the pressure of natural gas supplied in a pipeline.

15. The system of claim 12, further comprising:
an electric meter that monitors a supply of electric energy to a facility from a source other than that supplied by a backup generator.

16. A computer program product for ensuring backup generator fuel, the computer program product comprising a storage medium readable by a processing circuit and storing instructions for execution by the processing circuit for facilitating a method comprising:
monitoring availability of natural gas via a pipeline;
monitoring a fill level of compressed natural gas in at least one storage tank; and
refilling the at least one storage tank in response to the fill level of the at least one storage tank being less than a preset minimum fill level and natural gas being available via the pipeline.
